(19) United States
(12) Patent Application Publication
(10) Pub. No.: US 2008/0267800 A1
(43) Pub. Date: Oct. 30, 2008

(54) Reciprocating Pump

(75) Inventor: George Roderick McNeil, Christchurch (NZ)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Ecologics NZ Limited, Christchurch (NZ)

(21) Appl. No.: 11/813,258

(22) PCT Filed: Dec. 22, 2005
(86) PCT No.: PCT/NZ05/00340

§ 371 Date: Mar. 25, 2008

(30) Foreign Application Priority Data
Dec. 30, 2004 (NZ) 533840

(51) Int. Cl. F04B 43/02; F04B 45/04; F04B 33/00; F04B 9/14; F16K 15/14

(52) U.S. Cl. 417/473; 417/521; 417/559; 137/843

(57) ABSTRACT

A pump (60, 160) has a pair of working members (preferably diaphragms 1, 2, 101, 102) and a pump chamber (3, 4, 103, 104) associated with each working member is communicated via check valves (32-35, 132-135) to a suction manifold (30, 130) and to an outlet manifold (31, 131). A drive mechanism (10, 110) couples the working members so that they reciprocate together and a first of the working members performs an outlet stroke while a second of the working members performs a suction stroke. The suction and outlet manifolds (30, 130, 31, 131) are incorporated in a manifold assembly that connects the pair of diaphragms (1, 2, 101, 102) for coordinated reciprocation. A pair of manually-operated levers (J, 8, 107, 108) are connected together for opposite reciprocation and are drivingly connected to the working members (1, 2, 101, 102).

### TECHNICAL FIELD

The present invention relates to reciprocating pumps having manually-operated drive mechanisms. More particularly, but not exclusively, the invention also relates to dual diaphragm pumps. The invention also relates to check valves and to check valve assemblies for use in pumps.

### BACKGROUND ART

A problem with most manually-operated reciprocating pumps is caused by the fact that only a single lever is used to operate the pump; whilst providing a simple mechanism, this is not particularly ergonomically efficient or versatile. One reason for this is because the lever is designed to be hand-operated and thus primarily uses the muscles of the arms and upper body, whilst, in a typical person, the muscles associated with the leg are much stronger and more capable of use for extended periods.

Another problem with most manually-operated reciprocating pumps arises from the fact that the work of lifting the water via the pump mechanism occurs only during half the cycle generally, as the lever is pushed down, therefore uneven demands are placed on the user to supply energy to the pumping process.

A number of pump configurations have been built to address various of these disadvantages. Flywheels on these types of pumps help to spread the force requirements over the operating cycles, however they of course add significant weight to the pump. Pumps have been driven by a rotating crank to which a connecting rod is connected for developing the reciprocating motion. A bicycle type seating and pedalling arrangement has been proposed so as to use the stronger muscles in the legs, however this adds to the bulk and weight of the device, making it less readily portable.

There is a particular need in developing countries for a manually operated pump which can be easily used for extended periods of time and which efficiently lifts significant volumes of water. The pump must operate far from maintenance facilities and personnel, and so must be reliable and easily repaired. In addition, the pump should be of simple construction to achieve low manufacturing costs. It should also be relatively lightweight and compact, allowing it to be readily moved to meet different needs e.g. for small-scale mineral processing applications, fire-fighting etc.

It is an object of the present invention to provide a pump with a manually-operated drive mechanism which addresses the foregoing problems, or at least provide the public with a useful choice.

Dual-diaphragm pumps are known in the prior art and comprise a piston connecting the two diaphragms, the alternating movement of the piston being such that when one diaphragm performs the outlet stroke the other diaphragm performs the suction stroke. Each diaphragm is placed in a pump chamber to provide a pumped fluid pump chamber. Each pump chamber is connected via a pair of check valves to a suction manifold and to a pressure manifold. These pumps may be operated by compressed air applied to a compensation space in the pump chamber on the opposing side of the diaphragm (see for example WO 93/18305) or may be mechanically driven from a rotating power source through a slider-crank mechanism (as in U.S. Pat. No. 5,649,809).

These dual-diaphragm pumps have various advantages. They are dry running, self-priming and may be used in fields such as mining or mineral processing as they are able to handle liquid contaminated with solid material. However, they generally have relatively high manufacturing costs as they require shaft seals, rotating members and bearings for supporting the piston.

It is a further object of the present invention to provide a dual-diaphragm pump which addresses the foregoing problems or at least provides the public with a useful choice.

Any publication cited in this specification is hereby incorporated by reference, however this does not constitute an admission that the document forms part of the common general knowledge in the art, in New Zealand or in any other country. The applicant reserves the right to challenge the pertinency of any publication cited herein, or to challenge the accuracy of any assertion made in a cited publication. As used herein, the word “comprises” means “includes, but is not limited to” and its derivatives have a corresponding meaning.

### DISCLOSURE OF INVENTION

According to one aspect of the present invention there is provided a pump including:

a pair of working members capable of acting upon a pumped fluid, the working members defining two pump chambers, each pump chamber being communicated via check valves to a suction manifold and to an outlet manifold;

a drive mechanism coupling the working members so that they reciprocate together and when one working member performs an outlet stroke the other working member performs a suction stroke, characterised in that

the drive mechanism further includes a pair of manually-operated levers drivingly connected to the working members, the levers being operatively connected together for opposite reciprocation.

Preferably the working members are flexible diaphragms, but they may be pistons. For versatility the levers can be configured for use as either handles or pedals. Operation is accomplished by oppositely reciprocating the levers; that is, one lever is driven in one direction as the other lever is driven (and may also be drawn) in the opposite direction, and when the end of each stroke is reached, the motion of both levers is simultaneously reversed. The levers are preferably arranged to reciprocate substantially vertically so as to employ the user's weight. In this manner one lever is driven during each half cycle as one pump chamber completes its outlet stroke, thereby evening out the energy demands placed on the user.

It will be understood that the drive mechanism coupling the working members and connecting the levers for opposite reciprocation may be configured in a number of different manners within the scope of the invention. Preferably a manifold assembly incorporates the suction and outlet manifolds and the manifold assembly connects the working members together for coordinated reciprocation. By this arrangement the number of components in the pump can be reduced, providing a reduction in manufacturing cost. The manifold assembly is a lightweight component, the weight of which is preferably supported by the diaphragms. Alternatively, a linear bearing could be used to support the manifold assembly.

In a preferred embodiment the levers are pivoted about a first axis which extends substantially parallel to an axis of reciprocation of the connecting member, the drive mechanism includes a rocker pivoted about an axis substantially perpendicular to the first axis, the handles are operatively connected to the rocker which is drivingly connected to the manifold assembly for reciprocation thereof.

In an alternative embodiment each lever may be pivotally fixed to a respective connecting rod to which the respective working member is fastened, and the drive mechanism may include separate means for operatively connecting the levers for opposite reciprocation. Such means, for example, may include a chain drive with an end of the chain fixed to each lever and the chain supported between the levers on one or more idler cogs. Alternatively, a gear drive of a known type may be used for operatively connecting the levers for opposite reciprocation.

According to another aspect of the present invention there is provided a flapper check valve including:

a valve seat with a plurality of flow openings extending therethrough;

a valve member, including a plurality of contiguous flaps of resilient material movable toward and away from the valve seat, each flap closing at least one of the flow openings, and

clamping means for releasably securing the valve member to the valve seat.

The flaps are preferably formed by intersecting slits formed on the valve member, the slits being positioned such that the flaps are entirely supported by the valve seat around the periphery of each flow opening. The slits preferably intersect to align with the centre of an opening closed by the valve. When the opening closed by the valve is circular, the flaps are substantially segment-shaped.

Preferably the clamping means may include releasable fasteners for clamping the valve member and valve seat together. Alternatively other known clamping devices may be used.

While this check valve has particular application with regard to the above-described pump, it will be appreciated that it would be useful in other pumps and applications, particularly for use in developing countries or remote areas where its simplicity of construction and ease of repair are significant advantages.

The pump preferably includes (at least) a pair of check valves of the above-described type, one controlling inlet flow from the suction manifold, the other outlet flow to the outlet manifold, wherein each valve member includes apertures therethrough for connection to both the suction and outlet manifolds.

This invention provides a pump which is effective and efficient in operational use, which provides reduced maintenance costs, and which is portable and versatile in operation. The pump may be economically constructed and has an overall simple design with a low number and commonality of parts which minimizes manufacturing costs. Further aspects and advantages of the present invention will become apparent from the ensuing description which is given by way of example only.

### BRIEF DESCRIPTION OF THE DRAWINGS

FIG. 1a is a pictorial view of a preferred embodiment of present invention (having a ¼ section cutaway to expose the pump chambers);

FIG. 1b is a vertical section through the pumping chambers of the pump of FIG. 1a;

FIG. 2 is a pictorial view of the drive mechanism of the pump of FIG. 1a;

FIG. 3 is a detail illustrating the connection between the rocker and manifold assembly of FIG. 2;

FIG. 4 is a pictorial view of the chassis assembly of the pump of FIG. 1a;

FIG. 5 is an exploded view of a pump chamber of the pump of FIG. 1a;

FIG. 6 is a side elevation of the pump of FIG. 1a;

FIG. 7 is a side elevation an alternative embodiment of the pump of the present invention;

FIG. 8 is a cross-sectional view of one pump chamber of the pump of FIG. 7;

FIG. 9 is an exploded view of a valve pair of the pump of FIG. 7;

FIG. 10 is an end view of the inlet/outlet manifold together with a pedal and chain linkage of the pump of FIG. 7; and

FIG. 11 is a plan view of the components of FIG. 10.

### BEST MODES FOR CARRYING OUT THE INVENTION

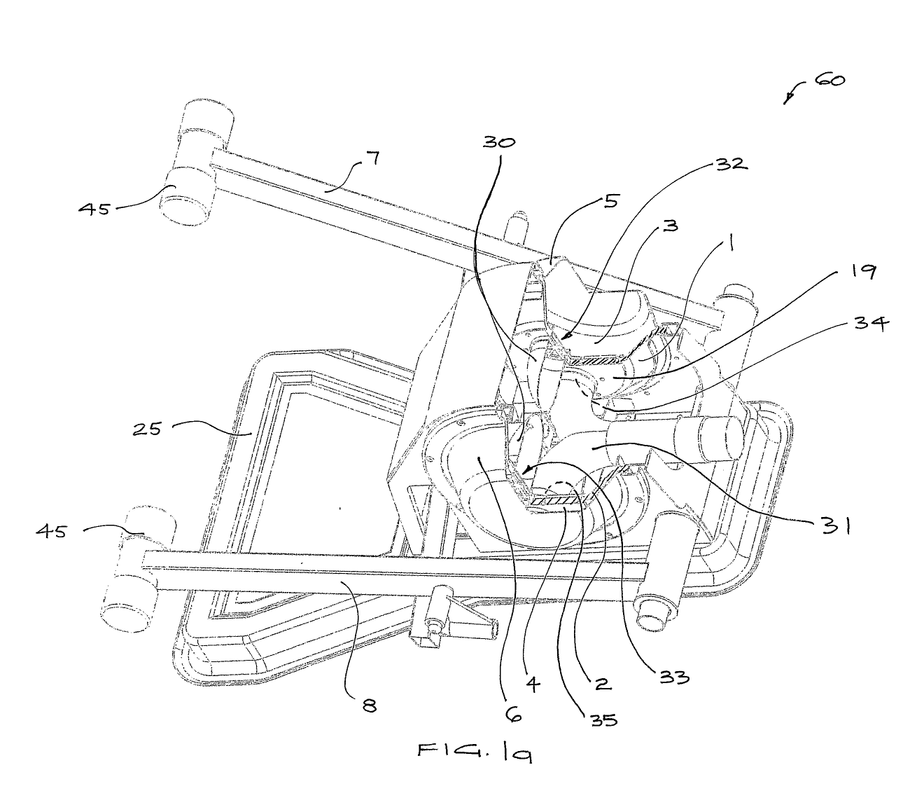

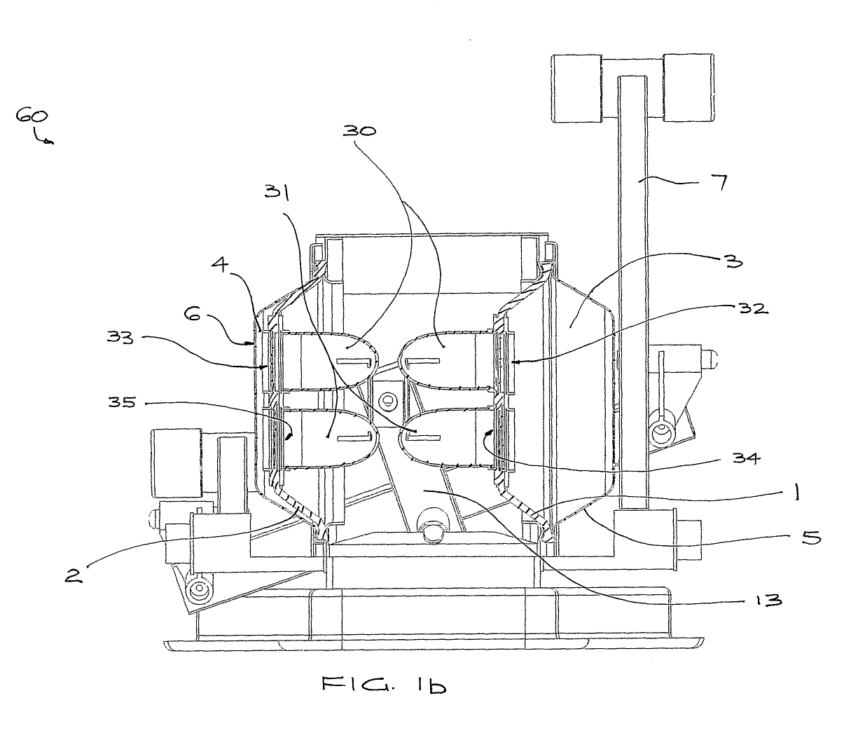

The preferred embodiment of the pump 60 of the invention is shown in FIGS. 1a-6. Referring to FIGS. 1a, 1b, pump 60 includes two working members in the form of elastomeric diaphragms 1, 2. Each of the diaphragms 1, 2 defines an associated pump chamber 3, 4 which is also bounded by a respective cap section 5, 6.

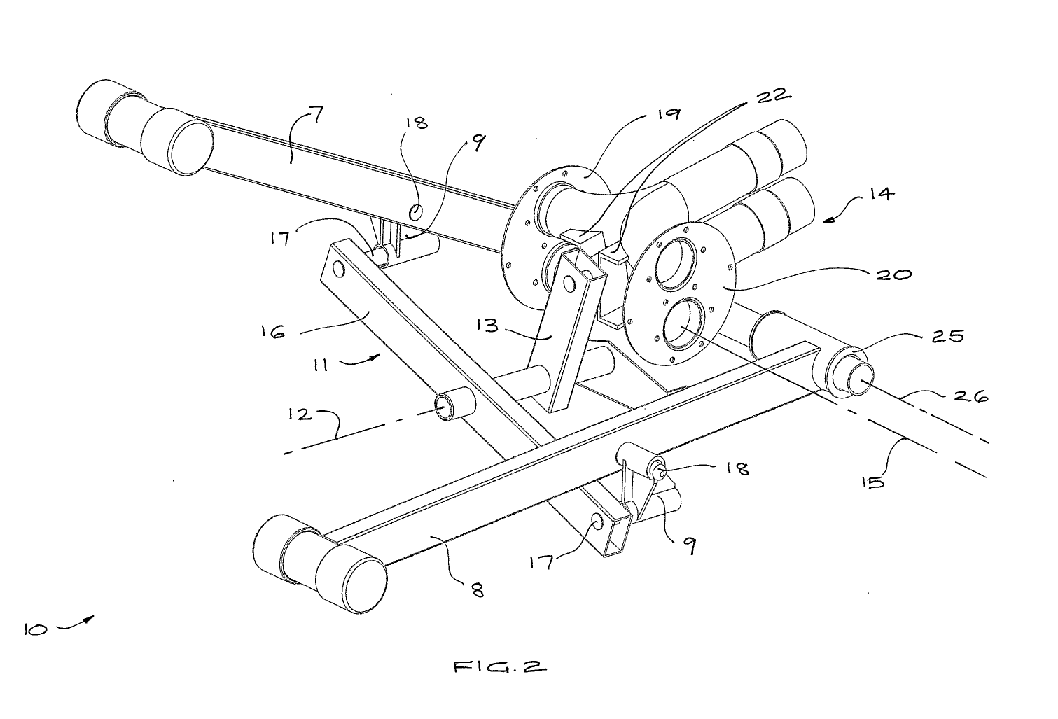

A drive mechanism 10 shown in FIG. 2 is provided for transforming reciprocating movement of the manually operated levers 7, 8 into reciprocating movement of the diaphragms 1, 2. The drive mechanism 10 has a rocker 11 pivoted about an axis 12 which lies generally in a central longitudinal plane (not shown) of the pump 60. The rocker 11 has a beam 16, the ends of which are connected to an intermediate portion of the levers 7, 8 via plastic bearing blocks 9. The blocks 9 have apertures having generally perpendicular axes in which the pins 17 and 18 (fixed to the beam 16 and levers 7, 8 respectively) are slidingly received to accommodate the relative movement between the rocker 11 and levers 7, 8. The rocker 11 further includes an arm 13 offset from the axis 12 and connected (as described below with reference to FIG. 3) to reciprocate the substantially rigid manifold assembly 14. The circular flanges 19, 20 of the manifold assembly 14 are fixed to the diaphragms 1 and 2 respectively so that they reciprocate together and diaphragm 1 performs an outlet stroke while diaphragm 2 performs a suction stroke.

The ends of the levers 7, 8 are mounted in journals 25 to pivot about axis 26 which extends generally parallel to the axis of reciprocation 15. This drive mechanism 10 is mechanically simple, low friction transformation of the lever 7, 8 movements to the linearly displaceable diaphragms 1, 2. No sliding bearing arrangement is necessarily required to support and guide the manifold assembly 14 which is sufficiently supported by the diaphragms 1, 2.

As shown in FIG. 3, the connection between the arm 13 and the manifold assembly 14 includes a low friction bearing block 23 slidingly received between the parallel faces 21 of two brackets 22 fixed to the manifold assembly 14. A pin 24 fixed to the end of the arm 13 is received in an aperture in the block 23.

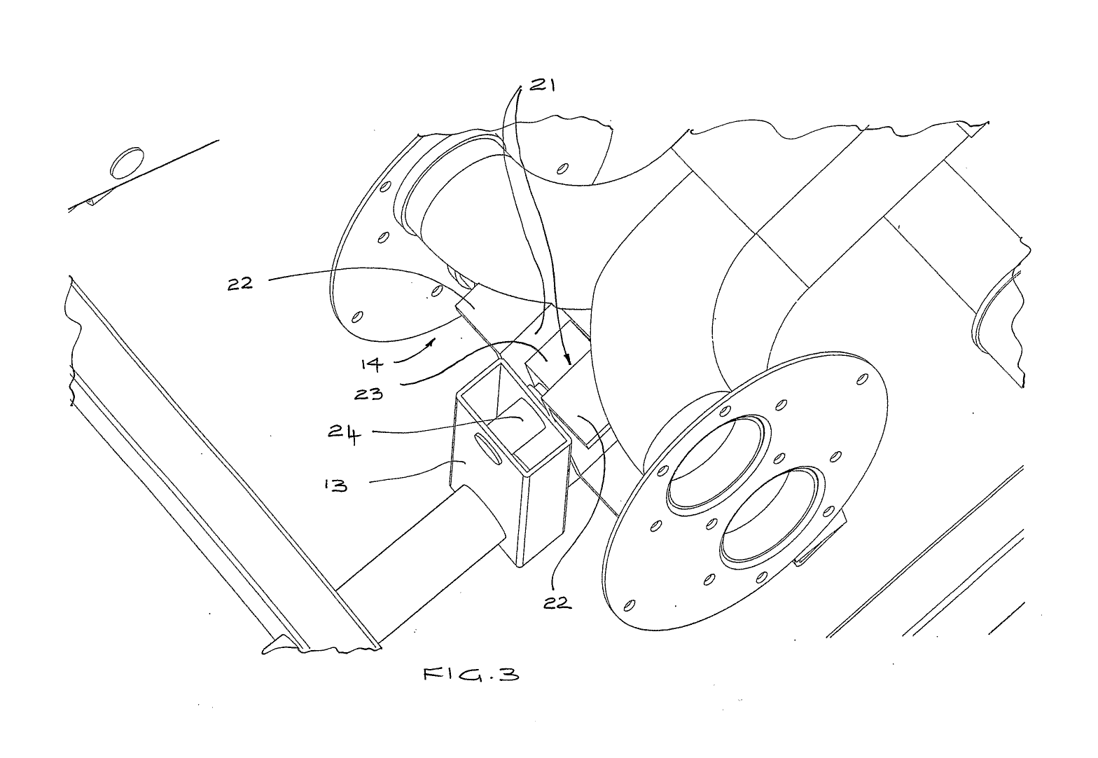

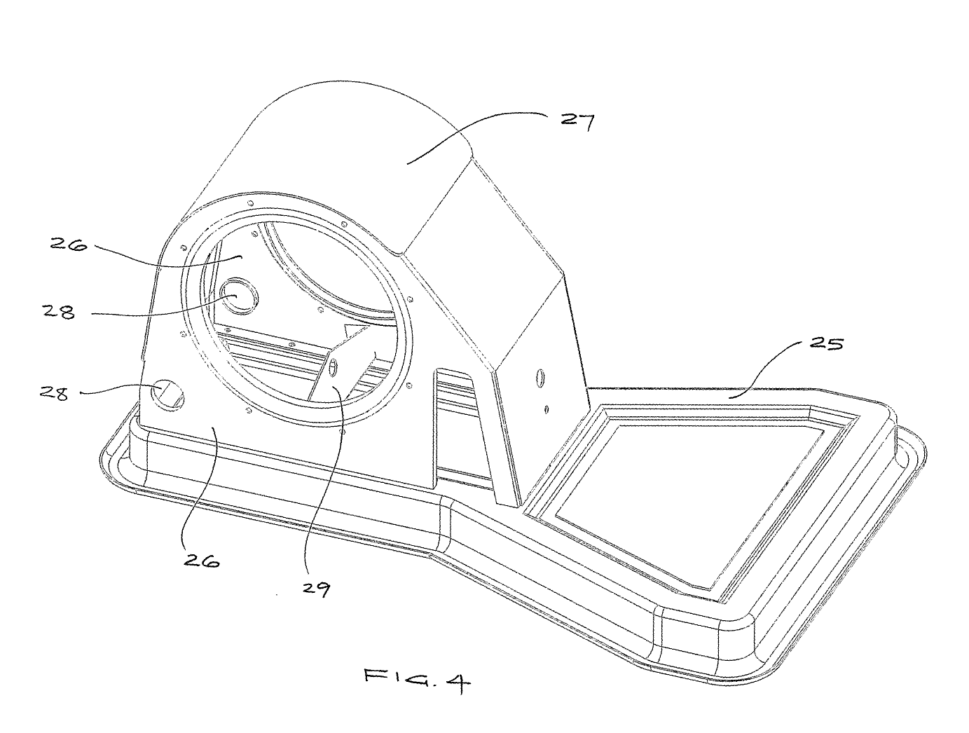

The chassis of the pump 60, as seen in FIG. 4, has a separately formed ground-supported base 25 to which two side members 26 are mounted and connected by a cover 27. The side members 26 have an aperture 28 for receiving an axle (not shown) for supporting the levers 7, 8. A bracket 29 is provided to mount the rocker 11. The chassis components, as well as the levers, and rocker etc can be made of various materials such as aluminium, or steel depending on the conditions of use. The diaphragms 26, 28 are made from rubber or a suitable natural or synthetic elastomer.

With reference to FIGS. 1a, 1b, and 5, as already mentioned the diaphragms 1, 2 define associated pump chamber 3, 4. The pump chambers 3, 4 communicate with a suction manifold 30 via flapper check valves 32, 33. The pump chambers 3, 4 also communicate with a pressure manifold 31 via flapper check valves 34, 35. The peripheral edge of the diaphragms 1, 2 are clamped between the side walls 26 and the cap sections 5, 6 by fasteners (not shown) fixed through a securing ring 36.

The check valves 32-35 are formed in pairs 32/34, 33/35 which are fixed to the diaphragms 1 and 2 respectively at the circular inlet and outlet openings 43, 44 of pump chamber 3, formed in the diaphragms 1, 2. Each of the pairs 32/34, 33/35 serve to control fluid flow into and out of the pump chamber. Each check valve and check valve pair is the same so only check valve 32 will be described. As illustrated the suction manifold 30 is uppermost, but the pump 60 could simply be configured so that the suction manifold 30 is the lower of the two by simply rotating the diaphragm.

FIG. 5 shows an exploded view of the preferred embodiment of the check valve pair 32/34 as fixed to diaphragm 1. The check valve 32 is comprised of: a relatively thin but rigid valve seat 40 with plurality of flow openings 41 extending therethrough; a valve member 56 adapted to be located on the valve seat, the valve member including a plurality of flap portions 42 movable toward and away from the valve seat, and a circular plate 46 generally corresponding to the flange 19. Fasteners (not shown) are used to clamp the check valve components between the ring 36 and the side members 26 to form integral check valve pair 32/34. The valve seats 40 are located in a recess 61 in opposing sides of the diaphragms 1, 2.

The flap portions 42 are formed by a pair of slits bisecting each other orthogonally at a point generally aligned with the centre of the opening 43. Each flap portion 42 is sector-shaped bounded by two contiguous radial edges (formed by the slits) and a circumferential edge which in operation forms a hinge. The radial edges abut and are aligned with the valve seat 40 such that the flap portions 42 are entirely supported by the valve seat 40 around the periphery of each opening 41. The periphery of each valve member 56 surrounds both the inlet 43 and outlet 44 openings, the flap portions 42 selectively closing one opening with an aperture 45 allowing unrestricted flow through the other opening.

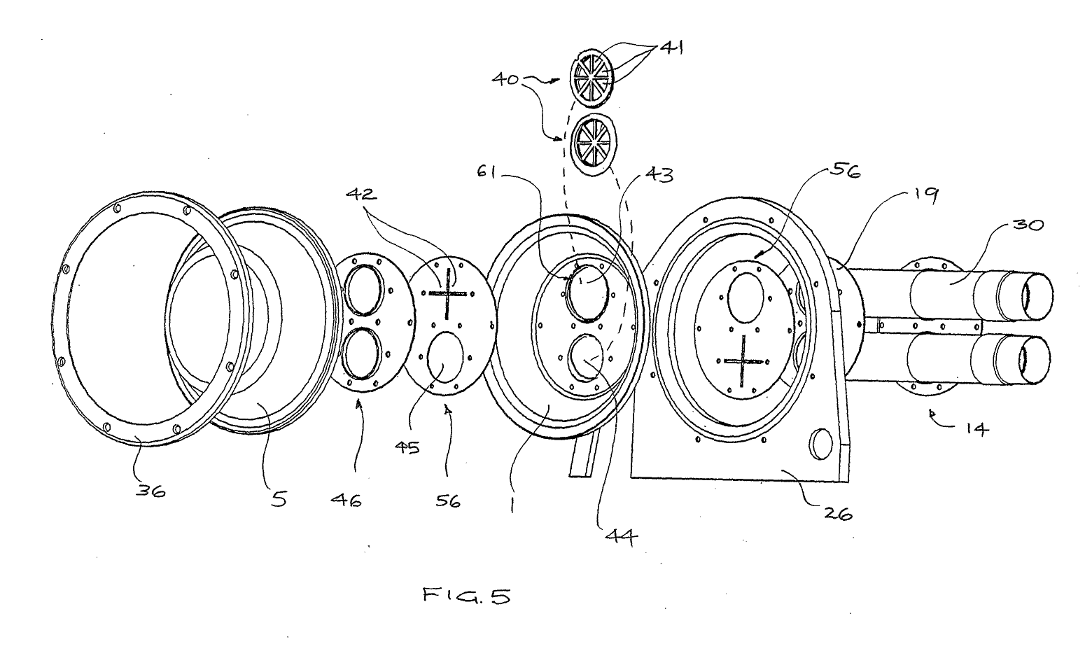

The pump 60 may conveniently be operated by a user's feet (or by his hands) employing the levers 7, 8 as pedals (or as handles). The supports 45 at the ends of the levers 7, 8 extend generally perpendicular to the longitudinal axis of the handles to form a T-shaped termination which provides lateral support to the user's foot and may be conveniently engaged with the user's heel. A handle or handles (not shown) fixed to the base 25 may be used to steady the user while he performs a repetitive stepping motion, with each foot transcribing a shallow arc as indicated by arrows X shown in FIG. 6. When the handles 7, 8 are oppositely reciprocated (that is, lever 7 is pushed down as lever 8 is driven up, and when the end of each pump stroke is reached, the lever motion is simultaneously reversed) the pump is positively driven i.e one of the diaphragms performs an outlet stroke while the other performs a suction stroke. The reciprocating movements of the levers 7, 8 are transformed into reciprocatory movements of the manifold assembly 14. The stroke of the manifold assembly 14 and accordingly that of the diaphragms 1, 2 is determined by the length of the arm 13. When it is intended to change the stroke, a rocker 11 having a different length arm 13 is to be used. As the manifold assembly 14 oscillates in operation, the inlet and outlet are conveniently connected by flexible conduits e.g. hoses. Also, depending upon the application of the pump the pulsation in the output from the pump may be further evened out by fixing an accumulator to the output.

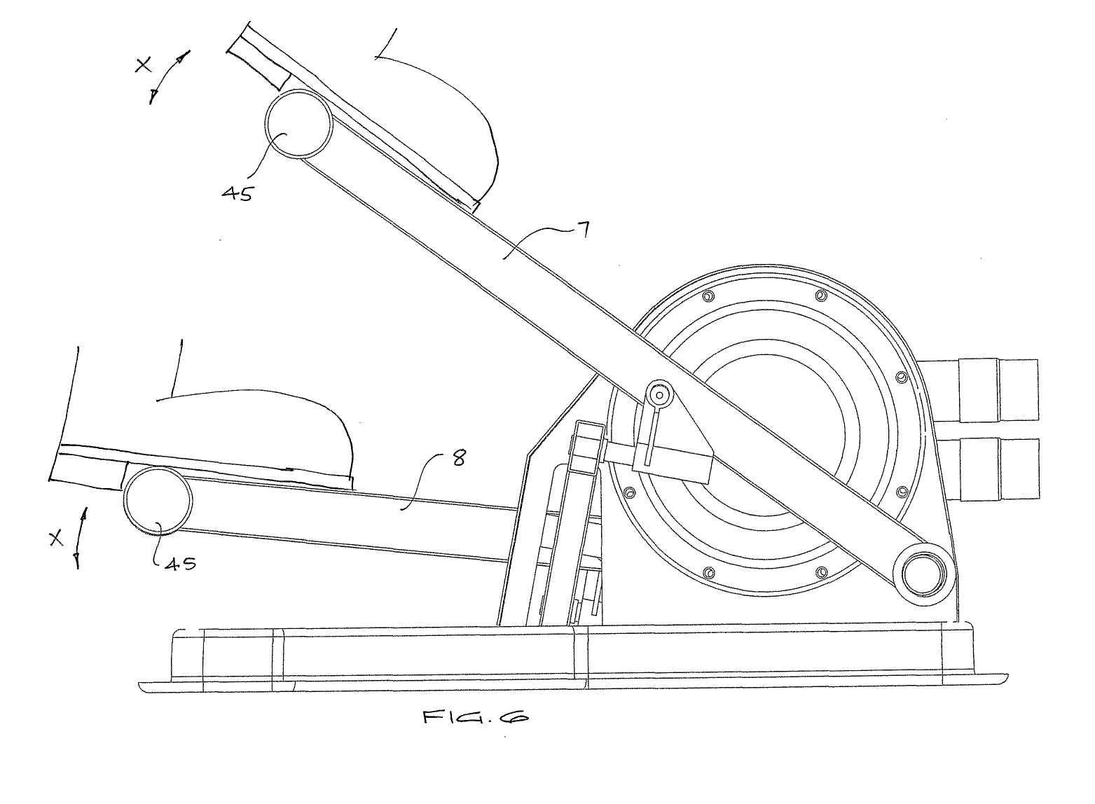

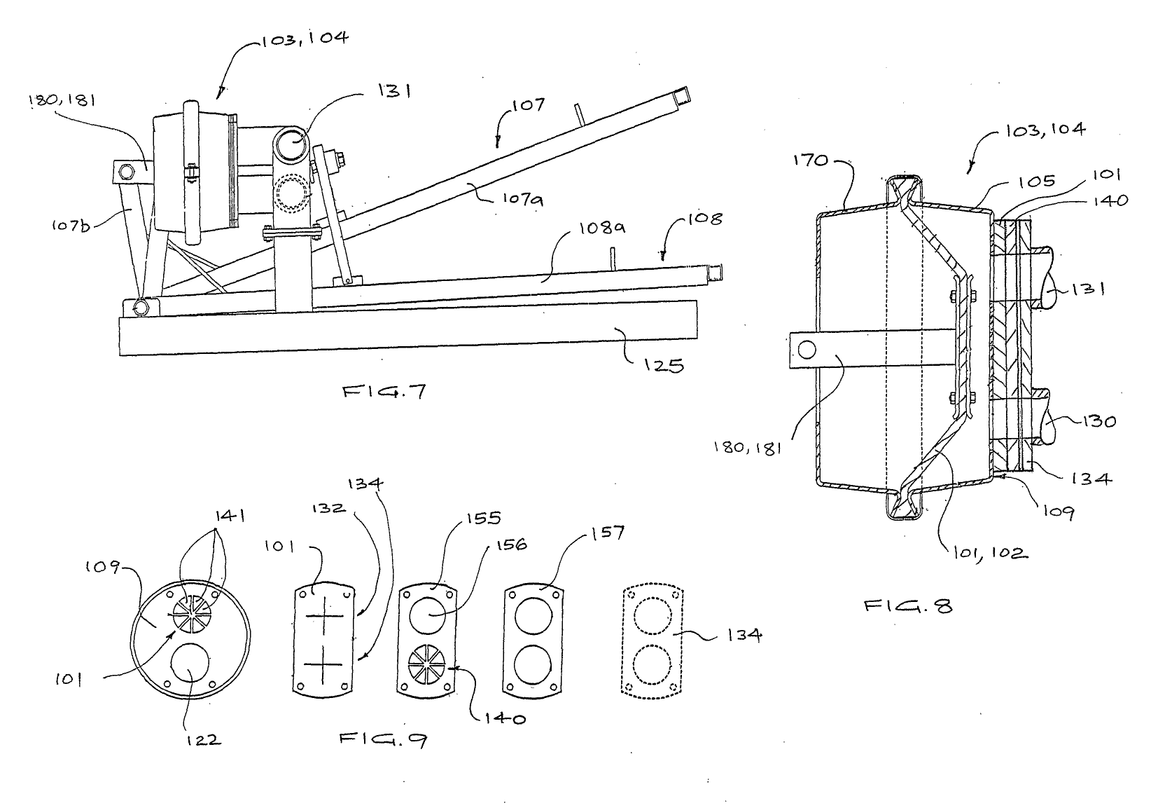

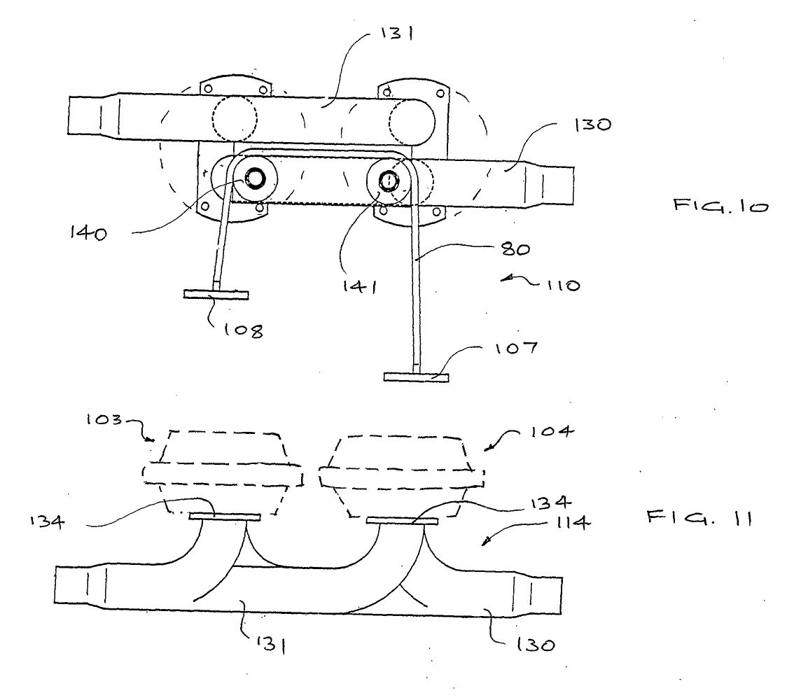

Referring now to FIGS. 7-11, an alternative embodiment of the portable manually-operated pump 160 of the present invention includes two identical pumping chambers 103, 104 each with working members in the form of diaphragms 101, 102. The centre part of each diaphragm 101, 102 is fixed by a drive mechanism 110 which includes connecting rod 180, 181 pivotally connected to a respective lever 107, 108. The levers 107, 108 include two elongate sections 107a, 107b, 108a, 108b rigidly connected in an L-shape and pivoted at their intersection. The suction manifold 130 and pressure manifold 131 are connected by rectangular flanges 134 to form the manifold assembly 114 which is fixed to the base 125 and communicates with both pump chambers 103, 104 . For providing the oppositely reciprocating movement of the levers 107, 108 the drive mechanism 110 further includes a chain 80, the opposing ends of which are connected to the levers 107, 108. The chain 80 is supported upon two idler cogs 140, 141 fixed to the manifold assembly 114 such that pushing down lever 107 raises lever 108 and vice versa.

Each pump chamber 103, 104 is composed from a cap section 105 having upper segment-shaped outlet apertures 141 and circular inlet aperture 122 and a similarly shaped cap 170 which are clamped together to hold the diaphragm 101 therebetween. The space between the diaphragm 101 and the cap 170 is open, having an opening through which the connecting rods 180,181 pass.

The check valves 132-135 are formed in pairs 132/134, 133/135 which are fixed to the front faces 109, 109a of each cap section 105. Each check valve 132 has the same general construction as the check valve 32 of the preferred embodiment, however, as shown the check valve pair 132/134 has a different construction incorporating a single valve member 101. As illustrated the pressure manifold 131 is uppermost and the outlet valve seat 101 is formed in the front face 109 of the cap section 105 and includes a plurality of apertures 141 therethrough. The valve member 125 is positioned between the front face 109, 109a of each cap section 105 and a valve support plate 155 having an upper circular opening 156 and a lower valve seat 140 of like construction to valve seat 101. A gasket 157 is provided on the outer face of the plate 155 and the components of the assembled valve pair 132/134 are clamped by fasteners (not shown) between the flange 134 of the manifold assembly 114 and the front face 109.

Aspects of the present invention have been described by way of example only and it should be appreciated that modifications and additions may be made thereto without departing from the scope thereof as defined in the appended claims.

1. A pump including:
a pair of working members capable of acting upon a pumped fluid, the working members defining two pump chambers, each pump chamber being communicated via check valves to a suction manifold and to an outlet manifold;
a drive mechanism coupling the working members so that they reciprocate together and when one of the working members performs an outlet stroke the other working member performs a suction stroke, characterised in that
the drive mechanism further includes a pair of manually-operated levers drivingly connected to the working members, the levers being operatively connected together for opposite reciprocation.

2. The pump as claimed in claim 1 wherein the suction and outlet manifolds are incorporated in a manifold assembly that connects the working members together for coordinated reciprocation.

3. The pump as claimed in claim 1 wherein the working members are flexible diaphragms.

4. The pump as claimed in claim 1 wherein at least one of the check valves is a flapper valve including:
a valve seat with a plurality of flow openings extending therethrough;
a valve member, including a plurality of contiguous flaps of resilient material movable toward and away from the valve seat, each flap closing at least one of the flow openings, and
clamping means for releasably securing the valve member to the valve seat.

5. The pump as claimed in claim 4 wherein the flaps are formed by intersecting slits formed on the valve member, the slits being positioned such that the flaps are entirely supported by the valve seat around the periphery of each flow opening.

6. The pump as claimed in claim 5 wherein the slits intersect to align with the centre of an opening closed by the valve.

7. The pump as claimed in claim 4 wherein the flaps are substantially segment-shaped.

8. The pump as claimed in claim 3 including a pair of check valves secured to each diaphragm, each check valve including:
a valve seat with a plurality of flow openings extending therethrough;
a valve member, including a plurality of contiguous flaps of resilient material movable toward and away from the valve seat, each flap closing at least one of the flow openings, and
clamping means for releasably securing the valve member to the valve seat.

9. The pump as claimed in claim 1 wherein each lever is pivotally fixed to a respective connecting rod to which the respective diaphragm is fastened, and the drive mechanism includes a chain drive for operatively connecting the levers for opposite reciprocation, the chain drive including a chain the opposing ends of which are fixed to each lever, and one or more idler cogs supporting the chain.

10. The pump as claimed in claim 1 wherein the handles are pivoted about a first axis which extends substantially parallel to an axis of reciprocation of the connecting member, the drive mechanism includes a rocker pivoted about an axis substantially perpendicular to the first axis, the handles are operatively connected to the rocker which is drivingly connected to the manifold assembly for reciprocation thereof.

11. A flapper check valve including:
a valve seat with a plurality of flow openings extending therethrough;
a valve member, including a plurality of contiguous flaps of resilient material movable toward and away from the valve seat, each flap closing at least one of the flow openings, and
clamping means for releasably securing the valve member to the valve seat.

12. The check valve as claimed in claim 11 wherein the flaps are formed by intersecting slits formed on the valve member, the slits being positioned such that the flaps are entirely supported by the valve seat around the periphery of each flow opening.

13. The check valve as claimed in claim 12 wherein the slits intersect to align with the centre of an opening closed by the valve.

14. The check valve as claimed in claim 11 wherein the flaps are substantially segment-shaped.

15-16. (canceled)
